(19) United States
(12) Patent Application Publication
(10) Pub. No.: US 2023/0240294 A1
(43) Pub. Date: Aug. 3, 2023

(54) COMPOSITION FOR CONTROLLING ECTOPARASITES

(71) Applicant: NOVIOPONICS B.V., Venlo (NL)

(72) Inventors: Ludan ZHOU, Venlo (NL); Yongjun MEN, Venlo (NL)

(21) Appl. No.: 18/012,365

(22) PCT Filed: Jun. 28, 2021
(86) PCT No.: PCT/EP2021/067644

§ 371 Date: Dec. 22, 2022

(30) Foreign Application Priority Data
Jun. 29, 2020 (NL) 2025939

(51) Int. Cl. A01N 43/16; A01N 25/30; A01N 25/02; A01P 7/02

(52) U.S. Cl. CPC A01N 43/16; A01N 25/30; A01N 25/02; A01P 7/02

(57) ABSTRACT

A composition including 1.5-40 wt. % sophorolipids, 0-7.5 wt. % of additives and a solvent; wherein the solvent is added to the composition to make up the total of 100% of the composition, for the treatment of hematophagous ectoparasite for infection\infestation. A method for treating a surface containing hematophagous ectoparasite, wherein the method includes the step of applying the composition at least 2 times, more preferably at least 3 times, and wherein the time between each application is at least 2 hours, preferably at least 8 hours.

### FIELD OF THE INVENTION

The present invention relates to a composition having hematophagous ectoparasite controlling activity, in particular to a composition having hematophagous ectoparasite controlling activity with respect to Mesostigmata, such as for example Dermanyssus gallinae, Ornithonyssus bursa, and Ornithonyssus sylviarum.

### BACKGROUND OF THE INVENTION

One problem which arises with known hematophagous ectoparasite control agents is that firstly resistances have built up to a number of hematophagous ectoparasite control agents (such as for example fipronil, carbaryl and cyfluthrin), secondly such insecticides enter the food chain via for example chickens and eggs exposed to such insecticides, and thirdly a number of hematophagous ectoparasite control agents which are still effective are prohibited by the authorities on account of their harmful side effects for animals, humans and the environment.

The above problem arises in particular with regard to the control of hematophagous ectoparasites in poultry (such as for example domestic fowls, including chickens, turkeys, geese and ducks), in particular in poultry farming.

It has been found that in the absence of suitable hematophagous ectoparasite control agents the condition of the chickens deteriorates. In the event of a Dermanyssus gallinae plague, the chickens suffer, for example, from anaemia. Furthermore, the condition of the chicken has an influence on its eggs, since the deterioration in the condition of the chicken lowers egg production. There is also a risk of the chicken's eggs becoming spotty. This means that the eggs have a less attractive appearance, causing their price to drop.

Therefore, it should be clear that in the specialist field there is an ongoing need to provide novel hematophagous ectoparasite control agents, that are at least one of the following cost effective, are less likely to induce resistance, are animal friendly, human friendly and the environment friendly.

U.S. Pat. No. 3,159,536, EP 0367934 and WO 01/35744 describe aqueous insecticidal compositions which contain a high percentage (based on dry matter) of hydrophobic silica. One drawback of aqueous insecticides is that they are difficult to apply. It has been found that with aqueous insecticides lumps may form, which can cause problems with spraying them. Moreover, it has been found that aqueous insecticides have a less effective activity.

Furthermore, it has been found that anti-hematophagous ectoparasite compositions with hydrophobic silica are not sufficiently effective under moist conditions such as those which are present in spaces in which chickens and other birds are kept, and that the silica dust causes chronic bronchitis, due to irritation, in farmers and persons exposed.

Therefore, it is an object of the present invention to provide a solution to the abovementioned problems. A further object of the present invention is to provide an inexpensive composition having hematophagous ectoparasite controlling activity which can be used in an ecologically favourable way, such as for example without harmful side effects on the environment, animals and humans.

### SUMMARY OF THE INVENTION

The above objects are achieved by the use of a composition comprising 1.5-40 wt. % sophorolipids, 0-7.5 wt. % of additives and a solvent; wherein the solvent is added to the composition to make up the total of 100% of the composition, for the treatment of hematophagous ectoparasite for infection\infestation.

Surprisingly, it has been found that, as demonstrated by tests, the composition according to the invention has a particularly effective hematophagous ectoparasite controlling activity. It has been found that in some cases the efficacy is in some cases insufficient if less than 1.5 wt. % of sophorolipid is used. Without being bound to any particular theory, it is believed by the inventors that concentrations of sophorolipids of 2-7.5 wt. % are particularly effective at blocking the nostrils of hematophagous ectoparasites, such as for example Dermanyssus gallinae. More than 40 wt. % of sophorolipid lead to an uneconomical composition, firstly due to the costs and secondly due to the high viscosity that interferes with the application of the composition. Moreover, such a high level makes the composition less effective if it is used under moist conditions such as those which are present in spaces in which chickens are kept.

A particular advantage of the composition according to the present invention is that the composition can be obtained easily, inexpensively, is biodegradable and ecological.

A further advantage of the composition according to the invention is that the composition is chemically safe, i.e. the composition is not combustible, explosive or particularly toxic. Also, the composition according to the invention is physically safe, since its separate constituents are also used in other household or food-related products.

### BRIEF DESCRIPTION OF THE FIGURES

FIG. 1: 0 hour after spraying. Dermanyssus gaffinae in a-e were sprayed with compositions comprising sophorolipids concentration of 0 wt. %, 0.6 wt. %, 1.2 wt. %, 2.5 wt. % and 5 wt. % respectively. All of the Dermanyssus gaffinae showed temporarily no movements after spraying.

FIG. 2: 72 hours after application. Dermanyssus gaffinae a-c) were sprayed with compositions comprising sophorolipids concentration of 0 wt. %, 0.6 wt. % and 1.2 wt. %, most Dermanyssus gaffinae were still active and formed clusters. Dermanyssus gallinae d and e were sprayed with compositions comprising sophorolipids concentration of 2.5 wt. % and 5 wt. %. The Dermanyssus gaffinae show no more activity or clustering.

### DETAILED DESCRIPTION OF THE INVENTION

The present invention provides the use of a composition comprising 1.5-40 wt. % sophorolipids, 0-7.5 wt. % of additives and a solvent; wherein the solvent is added to the composition to make up the total of 100% of the composition, for the treatment of hematophagous ectoparasite for infection\infestation. The present invention further provides a method for treating a surface containing hematophagous ectoparasite, wherein the method comprises the step of applying the composition at least 2 times, more preferably at least 3 times, and wherein the time between each application is at least 2 hours, preferably at least 8 hours.

Definition

According to the invention, the term “hematophagous ectoparasite controlling activity” does not per se indicate an insect-killing (insecticidal) activity, but rather may also indicate an activity which causes hematophagous ectoparasites to be repelled, inhibit their respiratory system or even to be immobilized in a certain position, provided only that the negative effects of the presence of the hematophagous ectoparasites to be controlled are alleviated or eliminated. Such effects may lead to the killing of hematophagous ectoparasites and/or diminished number of offspring (for example larvae, protonymphs or deutonymphs).

Composition

The invention relates to the use of a composition for the treatment of hematophagous ectoparasite for infection\infestation.

The composition may comprise 1.5-40 wt. % sophorolipids, preferably 1.6-20 wt. %, more preferably 1.7-15 wt. %, even more preferably 2-7.5 wt. %, most preferably 2.5-5 wt. %, 0-7.5 wt. % of additives and 52.5-98 wt. % of solvent.

The composition may comprise composition comprising 1.5-40 wt. % sophorolipids, 0-7.5 wt. % of additives and a solvent; wherein the solvent is added to the composition to make up the total of 100% of the composition.

In addition to sophorolipids, the composition according to the invention may also contain solvents and additives.

The composition according to the invention may further comprise 0.1-3.6 wt. % of additives.

The composition according to the invention may comprise a solvent at 52.5-98 wt. %, preferably 60-98.5 wt. %, more preferably 75-98 wt. %, more preferably 80-98.4 wt. %, more preferably 88.9-97.9 wt. %, more preferably 90-98.3 wt. %, more preferably 92.5-98 wt. %, more preferably 92.4-93.9 wt. %, more preferably 91.4-94.9 wt. %, most preferably 95-97.5 wt. %. Preferably the solvent is water.

The composition according to the invention may be used to treat hematophagous ectoparasite, Mesostigmata, Dermanyssus gaffinae, Ornithonyssus bursa, Ornithonyssus sylviarum, cimex lectularius and/or acarus scabiei infections/infestations. Preferably the composition may be used to treat to treat hematophagous ectoparasite, Mesostigmata, Dermanyssus gaffinae, Ornithonyssus bursa, and/or Ornithonyssus sylviarum.

The composition according to the invention can be applied to surfaces, such as for example coops, stalls, nests, creaks, seams and pillars.

The composition according to the invention is preferably in the form of a solution or liquid dispersion.

The composition according to the invention preferably comprises 2-7.5 wt. % sophorolipids, 75-98 wt. % of water and 0-7.5 wt. % of additives.

More preferably, the composition according to the invention comprises 2-7.5 wt. % sophorolipids and 92.5-98 wt. % of water.

The composition according to the invention comprises 2-7.5 wt. % sophorolipids, 88.9-97.9 wt. % of water and 0.1-3.6 wt. % of additives.

The composition according to the invention preferably has a surface tension 30-40 mN/m and has a critical micelle concentration of 40-100 mg/L.

The composition according to the invention preferably has a pH of 5-6.

The composition according to the invention preferably is 100% biodegradable according to the OECD 301 F standard test.

The composition according to the invention preferably is anaerobic biodegradable according to the EN ISO 11734 standard.

The composition according to the invention preferably is classified as non-skin irritant according to the Red Blood Cell (RBC) tests or the EPISKIN Human Skin Model Test (the method is detailed in RBC test, W. J. W. Pape, U. Hoppe, Drug Res.40 (I), 4, 498-502 (1990)), and as not sensitizing to the respiratory system according to the Local Lymph Node Assay, OECD 429 (Mouse).

The composition according to the invention preferably is labelled with the European Ecolabels for aerobic biodegradable, anaerobic biodegradable, low aquatic toxicity and low impact on aquatic life (allowing for higher dosages over other secondary surfactants).

The composition according to the invention may be prepared by mixing the sophorolipids with solvents and additives.

The person skilled in the art is aware of the methods of mixing ingredients, such as for example fluid and/or solid ingredients.

Sophorolipids

The compositions that are provided by the invention comprise sophorolipids, which can be prepared by fermentative processes. The sophorolipids may be prepared with non-GMO yeast, Starmerella Bombicola, at low temperature fermentation and without harmful by-products. The feedstock may be 100% renewable, such as European non-GMO vegetable sources as for example rapeseed oil and sugar beet. The sophorolipids according to this definition, and the sophorolipid preparations, may therefore comprise, for example, reactants from the fermentation process, such as fatty acids and carbohydrates, for example, which have served as substrates for the microorganisms, and also, for example, water and other natural impurities, especially organic impurities.

The sophorolipids of the invention may have a low CMC, such as for example 0.02 g/L, and/or a surface tension of 30-40 mN/m, which leads to a good decontamination ability for hematophagous ectoparasites, such as for example Dermanyssus gallinae. Furthermore, the sophorolipids of the invention may have low-foaming, even a substantially complete foam breaking effect, even at high concentration, such as for example 40 wt. %. The foam breaking effect of sophorolipids has been observed both in cold as well as in warm water. Such sophorolipids may be particularly suitable for spray-on coating and cleaning of surfaces, especially chicken coops.

Suitable sophorolipids may be REWOFERM® SL ONE by Evonik or SL18 by Ecover.

The sophorolipids may comprise 38-40 wt. % (rel.) and sophorolipid lactone (1 sophorolipid derivatives with diacetylated C18:1) and 59-61 wt. % (rel.) sophorolipid acid (2 C18:1 sophorolipid acid).

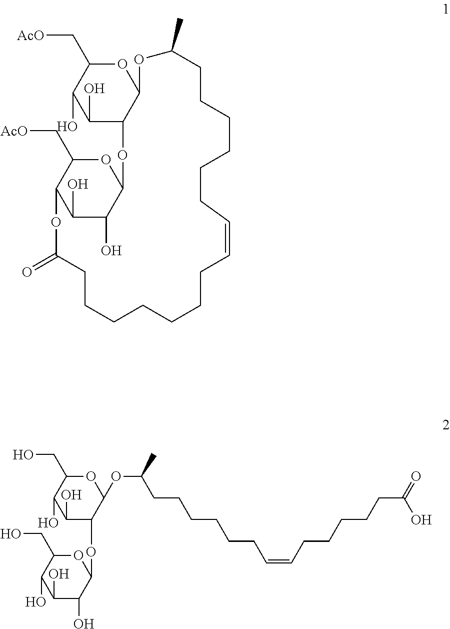

The sophorolipids may have a pH of 5-6.

The sophorolipids may have a critical micelle concentration (CMC) of at least 0.02 g/L at pH 5 and at a concentration of 40 wt. % of sophorolipids in the composition.

The sophorolipids may have a surface tension of 30-50 mM/m, preferably 35-40 mM/m at a concentration of 40 wt. % of sophorolipids in the composition.

The sophorolipids may lower the surface tension of water from 72.8 to 30-40 mN/m and may have a critical micelle concentration of 40-100 mg/L.

The sophorolipids may have a viscosity of 100-150 m Pas at a concentration of 40 wt. % of sophorolipids in the composition.

The sophorolipids may have a density of 1-1.10 g/mL at a concentration of 40 wt. % of sophorolipids in the composition.

The sophorolipids may be 100% biodegradable according to the OECD 301 F standard test.

The sophorolipids may be anaerobic biodegradable according to the EN ISO 11734 standard.

The sophorolipids may be 100% biorenewable Carbon Index (RCI).

The sophorolipids of the invention may be classified as non-skin irritant according to the Red Blood Cell (RBC) tests or the EPISKIN Human Skin Model Test (the method is detailed in RBC test, W. J. W. Pape, U. Hoppe, Drug Res.40 (I), 4, 498-502 (1990)), and as not sensitizing to the respiratory system according to the Local Lymph Node Assay, OECD 429 (Mouse).

The sophorolipids may be labelled with the European Ecolabels for aerobic biodegradable, anaerobic biodegradable, low aquatic toxicity and low impact on aquatic life (allowing for higher dosages over other secondary surfactants).

Additives

Potential additives may be surfactants, oils or polymers.

The surfactants may be selected from the group of lecithin, sodium stearoyl lactylate, polysorbates (like polysorbate 20, polysorbate 40, polysorbate 60, polysorbate 80), polyethyleneglycols, (like PEG2000, PEG5000, PEG10000, PEG20000), sorbitan esters (like for example sorbitan monolaurate (e.g. Span 20), sorbitan monostearate (e.g. Span 60) or sorbitan tristearate (e.g. Span 65)). Surfactants may be present at 0.1-2 wt. % relative to the total composition.

Oils may be selected from the group of sunflower oil, garlic oil and essential oils. Oils may be present at 0.1-5 wt. %.

Polymer may be selected from the group of amylopectin, amylose, starch and carboxymethyl cellulose. Polymers may be present at 0.1-0.5 wt. %.

Solvent

The composition according to the invention may comprise a solvent. The amount of the solvent would make the composition up to 100%.

Solvents may be water or alcohols. Preferably the solvent is water.

Hematophagous ectoparasite, Mesostigmata, Dermanyssus gaffinae, Ornithonyssus bursa, and Ornithonyssus sylviarum

Hematophagous ectoparasites are parasites that live outside the body of the host and feed on the blood of the host. Hematophagous ectoparasites jump on and off their hosts, such as for example Dermanyssus gaffinae.

Mesostigmata is an order of mites belonging to the parasitiformes. Most other mites are not parasitic. Mesostigmata contains many species of mites that are parasitic on reptiles, birds, and mammals. Mesostigmata include hematophagous species such as Laelaptidae, Dermanyssidae, Ornithonyssus, and Macronyssidae, i.e. hematophagous Mesostigmata ectoparasites. Among these are Dermanyssus gaffinae, Ornithonyssus bacoti, O. bursa, O. sylviarum, Echinolaelaps echidninus, Liponyssus sanguineus, Haemogamasus pontiger, and Eulaelaps stabularis. These species are attracted to warm objects and usually live on their host or in the nest of their host.

Species that infest poultry (O. sylviarum, O. bursa, and D. gaffinae) can be a problem for workers who handle infested chickens and turkeys. Bites of these mesostigmatid mites can cause an irritating inflammatory reaction. Although poultry mites prefer to feed on poultry, they can move onto humans and will bite if trapped by tight clothing or other binding objects such as casts. For example, Dermanyssus gaffinae has a life cycle that comprises feeding for 1-2 hours overnight on chickens and moving back to the coop (for example nest and pillars) for the remainder of the night and the day. The life cycle of the Dermanyssus gaffinae is 6-10 days. The Dermanyssus gaffinae larvae do not live on the chicken, but in the coop. In the first 3-5 days the Dermanyssus gaffinae larvae do not move on to the chicken. Between day 5-7 the Dermanyssus gaffinae protonymphs, Dermanyssus gaffinae deutonymphs and adult Dermanyssus gaffinae move onto the chicken overnight to feed for 1-2 hours.

Dermanyssus gaffinae usually infests poultry, may even cause death in poultry farms due to anaemia. They can be found in cracks and seams near the bedding areas and appear as white fuzz balls or salt-and-pepper—like deposits. Dermanyssus gaffinae will cause feather loss, irritation, and anaemia. The common clinical sign is anaemia. A bird with respiratory symptoms and a packed cell volume (PCV) of less than 30% should be suspected of having serious problems with hematophagous Mesostigmata ectoparasites.

Dermanyssus gallinae cause high economic losses in poultry industry worldwide, and are recognized as a vast economic, welfare and epidemiological problem for both birds (e.g. poultry) and humans. Only in Europe, the annual costs for the poultry industry correlated with Dermanyssus gallinae were estimated about 10 million euro. Therefore, different methods are being used to try to control Dermanyssus gallinae infections/infestations. Some strategies involve frequent cleaning of the poultry farms and application of desiccant powders, repellents derived from plants oils, or the treatment with acaricidal agents or traps. Other strategies focusing on biological methods were tested, such as Dermanyssus gallinae growth regulators, infection of Dermanyssus gallinae with pathogenic bacteria or fungi or the use of predatory mites. However, neither of these strategies has proven largely successful in eradicating the pest from poultry farms. Therefore, there is a high demand for innovative strategies for the control of Dermanyssus gallinae.

Method

The inventions also relates to a method for treating a surface containing hematophagous ectoparasite, wherein the method comprises the step of applying a composition comprising 1.5-40 wt. % sophorolipids, preferably 1.6-20 wt. %, more preferably 1.7-15 wt. %, even more preferably 2-7.5 wt. %, most preferably 2.5-5 wt. %, 0-7.5 wt. % of additives; wherein a solvent is added to the composition to make up the total of 100% of the composition; wherein the composition is applied at least 2 times; more preferably at least 3 times, and wherein the time between each application is at least 2 hours, preferably at least 8 hours.

The method may comprise the steps of a) applying a composition according to the invention to a surface for a first time; b) leaving the first applied composition to settle for at least 8 hours; c) applying the composition to the surface for a second time; d) leaving the second applied composition to settle for at least 8 hours.

The method may further comprise step e) applying the composition to the surface for a third time.

The method may preferably comprise the steps of a) applying the composition to a surface for a first time; b) leaving the first applied composition to settle for at least 1 day, preferably at least 2 days, most preferably 3 days; c) applying the composition to the surface for a second time; d) leaving the second applied composition to settle for at least 1 day, preferably at least 2 days, most preferably 3 days.

The method preferably further comprises step e) applying the composition to the surface for a third time.

During settling the composition may dry. The time period stated for the settling reflects the time between composition applications within a treatment cycle. A treatment cycle typically comprises at least 2 composition applications, preferably at least 3 composition applications, most preferably 3 composition applications. The composition may be applied at least 1 day apart from the following application (i.e. settling time), preferably at least 2 days apart from the following application, more preferably at least 3 days apart from the following application, most preferably 3 days apart from the following application. Typically, the following application may be within one week from the previous application, more preferably within 4 days of the previous application.

The method of treating a hematophagous ectoparasite, Mesostigmata, Dermanyssus gallinae, Ornithonyssus bursa, and/or Ornithonyssus sylviarum infection/infestation comprises application of at least 2 times of the composition according to the invention, preferably at least 3 times, most preferably 3 times.

The composition according to the invention can be applied to surfaces, such as for example coops, stalls, nests, creaks, seams and pillars.

The application of the surfaces may be through soaking, brushing, pouring, dripping or spraying.

The spraying may comprise a mist of particles. The inventors discovered that application of particles, i.e. very small droplets, of the composition is advantages, in that a better treatment of the surfaces can be achieved.

Preferably the composition is applied with a mist of particles, wherein the particles size (diameter) is of 0.3-2 μm, more preferably 0.4-1.5 μm, more preferably 0.45-1 μm, most preferably 0.5-0.7 μm.

0.5-0.7 μm particles are much smaller particles than used in standard spraying techniques. The small particles may remain longer in the application environment and much less liquid is therefore required to get the maximum contact surface.

Spraying may be conducted using a Gloria™ spraying machine.

The composition may be applied using a Gloria spraying machine, while spraying at a pressure of 0.5-3 bar, preferably 1-2.5 bar (maximum pressure 3 bar).

The composition according to the invention may be used in a method of treating hematophagous ectoparasite, Mesostigmata, Dermanyssus gallinae, Ornithonyssus bursa, or Ornithonyssus sylviarum infections/infestations.

Chickens are held under conventional farming conditions, biological conditions (such as for example EU Organic Label under Council Regulation (EC) No 834/2007, No 889/2008 and No 1235/2008) or Demeter™ conditions. Chickens may be held in a chicken coop at 3-18 chickens per m², preferably at 3-18 chickens per m², 4-15 chickens per m², most preferably at 5-9 chickens per m².

Per application and per 1000 chickens between 2.5-50 litres of the composition according to the invention may be applied, preferably between 3.5-45 litres/1000 chicken/application, more preferably 5-30 litres/1000 chickens/application, most preferably 10-15 litres/1000 chickens/application.

Per application and per 200 m² between 2.5-50 litres of the composition according to the invention may be applied, preferably between 3.5-45 litres/200 m²/application, more preferably 5-30 litres/200 m²/application, most preferably 10-15 litres/200 m²/application, wherein the amount of chickens per m² is 5-9, preferably 5.

Per application and per 66 m² between 2.5-50 litres of the composition according to the invention may be applied, preferably between 3.5-45 litres/66 m²/ₐpplication, more preferably 5-30 litres/66 m²/application, most preferably 10-15 litres/66 m²/application, wherein the amount of chickens per m² is 3-18, preferably 15.

The use of the composition and method according to the invention may lead to 6-12 months of a reduction in hematophagous ectoparasite, Mesostigmata, Dermanyssus gallinae, Ornithonyssus bursa, and/or Ornithonyssus sylviarum infection/infestation after at least 1 treatment cycle, preferably after a 2-time application within 10 days, most preferably after a 3-time application of the composition within 9 days.

It is noted that the invention relates to all possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the terms “including”, “comprising”, “having”, “containing” or “involving” do not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition.

Similarly, it is also to be understood that a description on a process comprising certain steps also discloses a process consisting of these steps. The process consisting of these steps may be advantageous in that it offers a simpler, more economical process.

When values are mentioned for a lower limit and an upper limit for a parameter, ranges made by the combinations of the values of the lower limit and the values of the upper limit are also understood to be disclosed.

The invention is now elucidated by way of the following examples, without however being limited thereto.

### EXAMPLES

### Experiment 1

The aim of this experiment was to determine the optimal sophorolipids concentration of the composition for the treatment of hematophagous ectoparasite, Mesostigmata, Dermanyssus gallinae, Ornithonyssus bursa, and/or Ornithonyssus sylviarum infestations.

TABLE 1
Compositions according to the invention

| | Sophorolipid | Solvent | | Additive |
|---|---|---|---|---|
| | wt. % in | wt. % in | | wt. % in |
| Examples | Composition | Composition | | Composition |
| Ex 1 | 0 | 100 | water | 0 |
| Ex 2 | 0.6 | 99.4 | water | 0 |
| Ex 3 | 1.2 | 98.8 | water | 0 |
| Ex 4 | 2.5 | 97.5 | water | 0 |
| Ex 5 | 5 | 95 | water | 0 |

The compositions were prepared by adding the sophorolipids to water to obtain the desired final sophorolipid concentrations of Table 1.

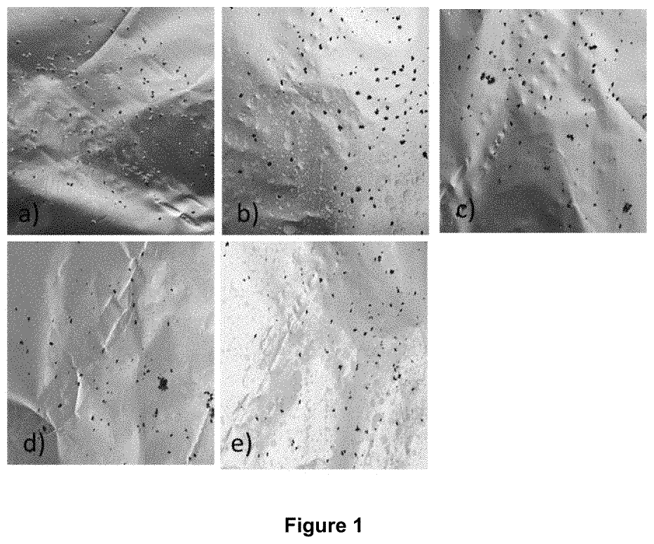

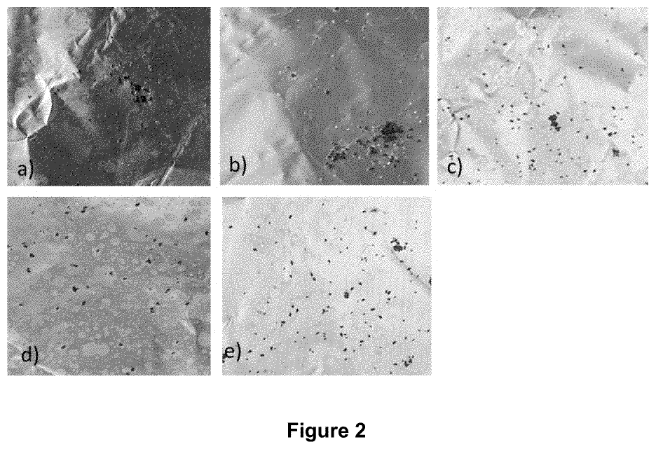

Fresh Dermanyssus gallinae were placed on aluminium foil. The aluminium foil with Dermanyssus gallinae was sprayed with compositions with different sophorolipids concentrations (see Ex1-5 of Table 1). The effect of the composition on Dermanyssus gallinae was observed at 0 hours and 72 hours after spraying (see FIGS. 1 and 2). 0 hour after spraying Dermanyssus gallinae with sophorolipids concentration of 0 wt. %, 0.6 wt. %, 1.2 wt. %, 2.5 wt. % and 5 wt. % (a-e of FIG. 1) all of the Dermanyssus gallinae showed temporarily no movements after spraying.

72 hours after application the Dermanyssus gallinae were sprayed with the composition with sophorolipids concentration of 0 wt. %, 0.6 wt. %, 1.2 wt. %, 2.5 wt. % and 5 wt. % of sophorolipids. Most Dermanyssus gallinae sprayed with 0 wt. %, 0.6 wt. % and 1.2 wt. % sophorolipids, showed still activity and formed clusters (see a-c of FIG. 2). Dermanyssus gallinae sprayed with 2.5 wt. % and 5 wt. % sophorolipids showed no more activity or clustering (see e and d of FIG. 2); small quantities of protonymphs and a number of deutonymphs were able to survive a few days but were unable to move.

### Experiment 2

The aim of this experiment was to determine the treatment method of hematophagous ectoparasite, Mesostigmata, Dermanyssus gallinae, Ornithonyssus bursa, and/or Ornithonyssus sylviarum infestations using the composition comprising sophorolipids.

The experiment was conducted on a chicken coop, that inhabits 9000 chickens. The treatment was applied to 3 different areas; Group 1, Group 2 and Group 3, which each comprised on average 3000 chickens. The chickens were free to roam between the areas, Group 1, Group 2 and Group 3. In each area the treatment was applied 2 times using spraying machine Gloria (with a maximum pressure of 3 bar; generally, the pressure was kept between 1-2.5 bar) giving a mist. The particles of the mist were 0.5-0.7 pm in diameter. The 2 applications were 13 days apart. The success of the treatment was assessed using AviVet Trap™ for Dermanyssus gallinae. The AviVet Traps™ were placed in certain places to collect Dermanyssus gallinae. AviVet Traps™ were placed before and after the treatment with the composition and collected at different time points to assess the effectiveness of the treatment on Dermanyssus gallinae. The number (weight) of the Dermanyssus gallinae was compared before and after application.

Each area houses 3000 chickens. The area of Group 2 was the control group and was sprayed with water instead of the composition. Group 2 was located between Group 1 and Group 3. Group 1 and Group 3 were treated with the composition comprising 2.5 wt. % sophorolipids with 7.5-15 litres/Group/per application.

On day 1 AviVet Trap™ were placed. On day 3 AviVet Traps™ were collected. Thereafter, on day 3, Group 1 was treated for the first time with 2.5 wt. % sophorolipids with 15 litres, and Group 3 was treated for the first time with 2.5 wt. % sophorolipids with 7.5 litres. Group 2 was sprayed with water. Finally, on day 3 new AviVet Traps™ were placed. On day 6 AviVet Traps™ were collected. On day 10 new AviVet Traps™ were placed.

On day 13 AviVet Traps™ were collected. Thereafter, on day 13, Group 1 was treated for the second time with 2.5 wt. % sophorolipids with 10 litres, and Group 3 was treated for the second time with 2.5 wt. % sophorolipids with 10 litres. Group 2 was sprayed with water. Finally, on day 13 new AviVet Traps™ were placed. On day 16 AviVet Traps™ were collected.

TABLE 2
The number of Dermanyssus gallinae in AviVet Traps ™ before
and after the first application.

| Group 1 | Before treatment | After treatment | effectiveness |
|---|---|---|---|
| | 125 | 40 | 68% |
| | 201 | 41 | 80% |
| | 512 | 193 | 62% |
| | 129 | 96 | 26% |
| Average | 242 | 93 | 62% |
| Group 2(control) | 1170 | 268 | 77% |
| | 957 | 145 | 85% |
| | 1130 | 279 | 75% |
| | 906 | 232 | 74% |
| Average | 1041 | 231 | 78% |
| Group 3 | 392 | 94 | 76% |
| | 622 | 134 | 78% |
| | 540 | 313 | 42% |
| Average | 518 | 180 | 65% |

Key: Effectiveness = Effectiveness of reducing Dermanyssus gallinae.

TABLE 3
The average Dermanyssus gallinae in AviVet Traps ™
from Group 1 to 3. In treated Group 1 and Group 3, a small reduction
in Dermanyssus gallinae can be seen compared to control Group 2.

| Groups | Before treatment | After treatment | effectiveness |
|---|---|---|---|
| Group 1 | 242 | 93 | 62% |
| Group 2 (control) | 1041 | 231 | 78% |
| Group 3 | 518 | 180 | 65% |

Key: Effectiveness = Effectiveness of reducing Dermanyssus gallinae.

TABLE 4
The number of Dermanyssus gallinae in AviVet Traps ™ before
and after the second application.

| Group 1 | Before treatment | After treatment | effectiveness |
|---|---|---|---|
| | 655 | 233 | 64% |
| | 315 | 242 | 23% |
| | 636 | 198 | 69% |
| Average | 535 | 224 | 58% |
| Group 2(control) | 499 | 443 | 11% |
| | 354 | 669 | −89% |
| | 240 | 372 | −55% |
| | 730 | 611 | 16% |
| Average | 456 | 524 | −15% |
| Group 3 | 357 | 265 | 26% |
| | 527 | 490 | 7% |
| | 434 | 249 | 43% |
| Average | 439 | 335 | 24% |

Key: Effectiveness = Effectiveness of reducing Dermanyssus gallinae.

TABLE 5
The average Dermanyssus gallinae in AviVet Traps ™ from
Group 1 to 3. In treated Group 1 and Group 3 there is a
clear reduction in Dermanyssus gallinae.

| Groups | Before treatment | After treatment | effectiveness |
|---|---|---|---|
| Group 1 | 488 | 260 | 58% |
| Group 2 (control) | 456 | 524 | −15% |
| Group 3 | 439 | 335 | 24% |

Key: Effectiveness = Effectiveness of reducing Dermanyssus gallinae.

It is shown that surprisingly a significant decrease of Dermanyssus gaffinae was achieved after two applications (Group 1 and Group 3) compared to no treatment (Group 2).

### Experiment 3

The aim of this experiment is to determine an optimal treatment method of hematophagous ectoparasite, Mesostigmata, Dermanyssus gaffinae, Ornithonyssus bursa, and/or Ornithonyssus sylviarum infestations using the composition comprising sophorolipids.

The experiment is conducted on a chicken coop, that inhabits 9000 chickens. The treatment is applied 3 times using spraying machine Gloria (with a maximum pressure of 3 bar; generally, the pressure is kept between 1-2.5 bar). The particles of the mist are 0.5-0.7 μm in diameter. The 3 applications are 3 days apart. The success of the treatment is assessed using AviVet Trap™ for Dermanyssus gallinae. The AviVet Traps™ are placed in certain places to collect Dermanyssus gallinae. AviVet Traps™ are placed before and after the application with the composition and collected at different time points to assess the effectiveness of the treatment on Dermanyssus gallinae. The number (weight) of the Dermanyssus gallinae is compared before and after application. The area is treated with the composition comprising 2.5 wt. % sophorolipids with 7.5-15 litres/per application.

On day -3 AviVet Trap™ are placed. On day 0 AviVet Traps™ are collected. Thereafter, on day 0, the area is treated for the first time with 2.5 wt. % sophorolipids with 15 litres. Finally, on day 0 new AviVet Traps™ are placed. On day 3 AviVet Traps™ are collected. Thereafter, on day 3, the area is treated for the second time with 2.5 wt. % sophorolipids with 15 litres. Finally, on day 3 new AviVet Traps™ are placed.

On day 6 AviVet Traps™ are collected. Thereafter, on day 6, the area is treated for the third time with 2.5 wt. % sophorolipids with 15 litres. Finally, on day 6 new AviVet Traps™ are placed. The day 6 AviVet Traps™ are collected at day 16.

On day 16 the reduction in Dermanyssus gallinae is reduced by over 75%.
What is claimed is:

1. Use of A method for treatment of hematophagous ectoparasite for infection/infestation, comprising the steps of:
obtaining a composition comprising 1.5-40 wt. % sophorolipids, 0-7.5 wt. % of additives and a solvent; wherein the solvent is added to the composition to make up the total of 100% of the composition, and
using the composition for the treatment of hematophagous ectoparasite for infectionlinfestation, and wherein said hematophagous ectoparasite is selected from the group of Mesostigmata, Dermanyssus gallinae, Ornithonyssus bursa, Ornithonyssus sylviarum, cimex lectularius and/or acarus scabiei.

2. The method according to claim 1, wherein the sophorolipids are present at 1.6-20 wt. %.

3. The method according to claim 1, wherein said hematophagous ectoparasite is Mesostigmata, Dermanyssus gallinae, Ornithonyssus bursa, and/or Ornithonyssus sylviarumi.

4. The method according to claim 1, wherein the composition is for use as an anti-hematophagous ectoparasiticide present on an effected surface, wherein said composition is applied at least 2 times to the affected surface.

5. The method according to claim 1, wherein the composition comprises 0.1-3.6 wt. % additives.

6. The method according to claim 1, wherein the solvent is present at 52.5-98 wt %.

7. The method according to claim 1, wherein said solvent is water.

8. The method according to claim 1, wherein the additive is one or more of surfactants, oils and polymer.

9. The method according to any one of claim 1, wherein the surfactant is one or more of lecithin, sodium stearoyl lactylate, polysorbate 20, polysorbate 40, polysorbate 60, and polysorbate 80; and wherein the surfactant is present at 0.1-2 wt. %.

10. The method according to claim 1, wherein the oil is one or more of sunflower oil, garlic oil and essential oils; and wherein the oil is present at 0.1-5 wt. %.

11. The method according to claim 1, wherein the polymer is one or more of amylopectin and amylose. and wherein the polymer present at 0.1-0.5 wt. %.

12. The method according to claim 1, further including the step of applying the composition at least 2 times to a surface; wherein the time between each application is at least 2 hours.

13. The method according to claim 12 further comprising the steps of a) applying a composition according to the invention to a surface for a first time; b) leaving the first applied composition to settle for at least 8 hours, c) applying the composition to the surface for a second time; and d) leaving the second applied composition to settle for at least 8 hours.

14. The method according to claim 13, further comprising step e) applying the composition to the surface for a third time.

15. The method according to claim 10, wherein per application and per 1000 chickens between 2.5-50 litres of the composition is applied.

16. The method according to claim 1, wherein the sophorolipids are present at 1.7-15 wt. %, and wherein the solvent is present at 60-98.5 wt. %,

17. The method according to claim 1, wherein the sophorolipids are present at 7.57 wt. %, and wherein the solvent is present at 75-98 wt. %,

18. The method according to claim 1, wherein the sophorolipids are present at 2.5-5 wt. %, and wherein the solvent is present at 95-97.5 wt. %.

19. The method according to claim 12, further comprising the steps of a) applying a composition according to the invention to a surface for a first time; b) leaving the first applied composition to settle for at least 1 day; c) applying the composition to the surface for a second time; and d) leaving the second applied composition to settle for at least 1 day; and wherein per application and per 1000 chickens between 3.5-45 litres of the composition is applied.

20. The method according to claim 12, further comprising the steps of a) applying a composition according to the invention to a surface for a first time; b) leaving the first applied composition to settle for at least 3 days; c) applying the composition to the surface for a second time; and d) leaving the second applied composition to settle for at least 3 days; and wherein per application and per 1000 chickens between 10-15 litres of the composition is applied.
